(19) United States
(12) Patent Application Publication
(10) Pub. No.: US 2018/0232673 A1
(43) Pub. Date: Aug. 16, 2018

(54) LAB QUALITY MANAGEMENT SYSTEM

(71) Applicant: U.SA. as represented by the Administrator of the National Aeronautics and Space Administration, Washington, DC (US)

(72) Inventor: GREGORY WOOD, ODENTON, MD (US)

(21) Appl. No.: 15/432,502

(22) Filed: Feb. 14, 2017

(51) Int. Cl. G06Q 10/06

(52) U.S. Cl. CPC G06Q 10/0633; G06Q 10/06311

(57) ABSTRACT

A method for managing equipment quality, by a management system includes receiving lab data for at least one lab location, and receiving equipment data comprising usage records for a plurality of equipment located at the at least one lab location. The management system generates a risk score for each of the plurality of equipment based on the lab data and the equipment data, and records a schedule for use of the plurality of equipment comprising dates and times, based on the usage records. The management system receives a request to reserve one of the plurality of equipment at a requested date and time, and determines whether to grant the request based on the risk score and the schedule for the one of the plurality of equipment.

### BACKGROUND

### Field

This application relates to quality assurance, and more particularly to a system and method for managing equipment quality.

### Background

Quality assurance (QA) is a way of preventing mistakes or defects in manufactured products and avoiding problems when delivering solutions or services. Quality assurance generally includes performing inspections and testing. For example, when large components or systems have undergone complete installation, they are commonly tested to determine if they are operable. As another example, inspection “walk-throughs” by QA personnel are common.

Information pertaining to various laboratories is often stored in multiple spreadsheets from which the data had to be manually maintained on a monthly basis. The separate spreadsheets created reports which were inconsistent. Quality control managers may experience difficulty in gathering current information from individuals operating from a multitude of laboratories. The difficulty is particularly evident when events such as updates or changes of the lab operations, lab manager re-certification, etc. occur. In the event of a laboratory safety incident, emergency personnel may potentially be unaware of possible hazardous chemicals and other conditions of the laboratory that may pose a safety risk.

### SUMMARY

The following presents a simplified summary of one or more embodiments in order to provide a basic understanding of present technology. This summary is not an extensive overview of all contemplated embodiments of the present technology, and is intended to neither identify key or critical elements of all examples nor delineate the scope of any or all aspects of the present technology. Its sole purpose is to present some concepts of one or more examples in a simplified form as a prelude to the more detailed description that is presented later.

In accordance with one or more aspects of the examples described herein, systems and methods are provided for managing equipment quality.

In an aspect, a method for managing equipment quality, by a management system includes receiving lab data for at least one lab location, and receiving equipment data comprising usage records for a plurality of equipment located at the at least one lab location. The management system generates a risk score for each of the plurality of equipment based on the lab data and the equipment data, and records a schedule for use of the plurality of equipment comprising dates and times, based on the usage records. The management system receives a request to reserve one of the plurality of equipment at a requested date and time, and determines whether to grant the request based on the risk score and the schedule for the one of the plurality of equipment.

In a second aspect, system for managing equipment quality includes a graphical user interface, a processor, and a memory coupled to the processor for storing data. The graphical user interface is configured to receive lab data for at least one lab location, receive equipment data comprising usage records for a plurality of equipment located at the at least one lab location, record a schedule for use of the plurality of equipment comprising dates and times, based on the usage records, and receive a request to reserve one of the plurality of equipment at a requested date and time. The processor is configured to generate a risk score for each of the plurality of equipment based on the lab data and the equipment data, and determine whether to grant the request based on the risk score and the schedule for the one of the plurality of equipment.

### BRIEF DESCRIPTION OF THE DRAWINGS

These and other sample aspects of the present technology will be described in the detailed description and the appended claims that follow, and in the accompanying drawings, wherein:

FIG. 1 illustrates an example system for managing equipment quality:

FIG. 2 illustrates an example methodology for managing equipment quality; and

FIG. 3 illustrates a block diagram of an example computer system.

### DETAILED DESCRIPTION

The subject disclosure provides techniques for managing equipment quality, in accordance with the subject technology. Various aspects of the present technology are described with reference to the drawings. In the following description, for purposes of explanation, numerous specific details are set forth in order to provide a thorough understanding of one or more aspects. It can be evident, however, that the present technology can be practiced without these specific details. In other instances, well-known structures and devices are shown in block diagram form in order to facilitate describing these aspects. The word “exemplary” is used herein to mean “serving as an example, instance, or illustration.” Any embodiment described herein as “exemplary” is not necessarily to be construed as preferred or advantageous over other embodiments.

The subject disclosure provides a system and method for managing equipment located in one or more lab locations. The system and method allows a user to input various data for each lab and for each item of equipment in the labs, as well as keep track of a schedule of use for the equipment. The system provides users with a risk score for the equipment and grants or rejects reservation requests for use of the equipment.

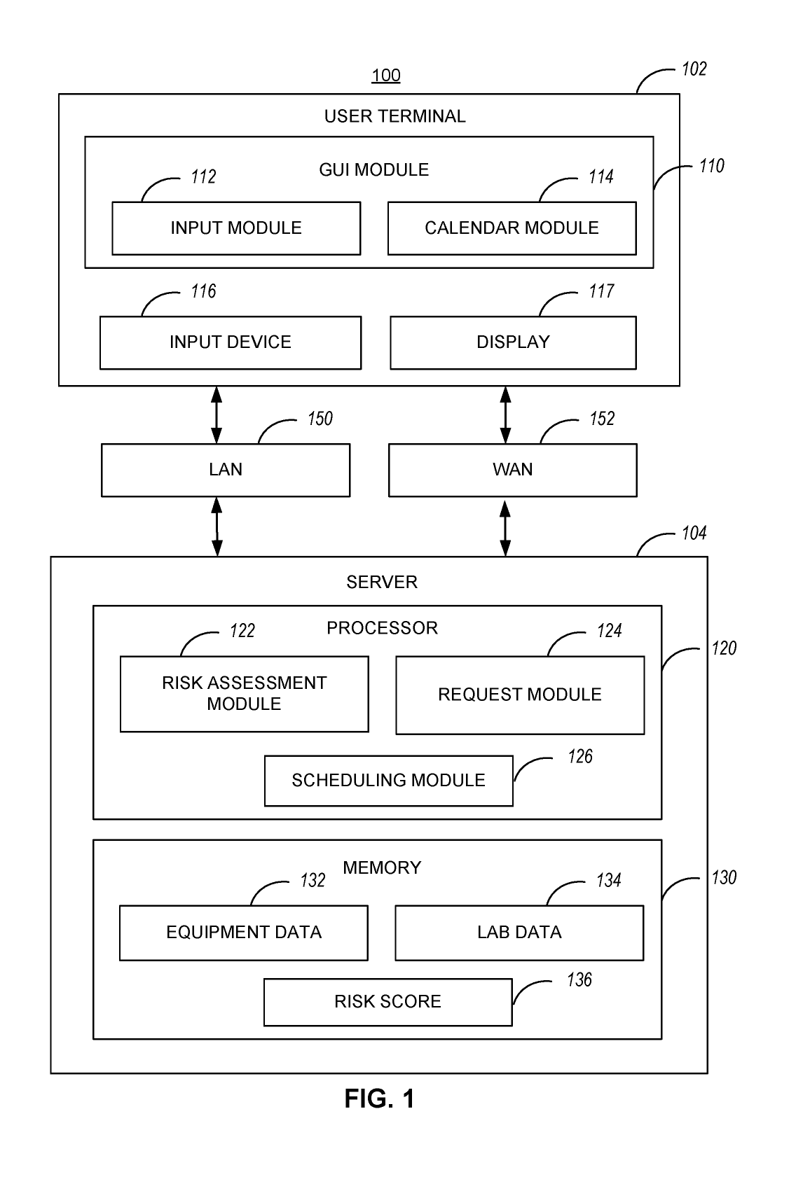

FIG. 1 illustrates an example system 100 for managing equipment quality. In some implementations, a system 100 for managing equipment quality includes at least one user terminal 102 and a server 104. Each user terminal 102 can connect to the server 104 over a network such as a local area network (LAN) 150 or a wide area network (WAN) 152, such as the Internet. It is understood that the user terminal 102 and the server 104 can be integrated into a single machine. Likewise, the server 104 is not necessarily a single machine, but can be distributed over multiple machines.

In some implementations, the user terminal 102 includes a graphical user interface (GUI) module 110, an input device 116, a display 117, and a network interface 118. For example, the user terminal 102 can be a desktop computer, a laptop, a tablet, a smartphone, a mobile device, a virtual machine, or other such device.

The display device 117 can be at least one of a monitor, a light-emitting display (LED) screen, a liquid crystal display (LCD) screen, a head mounted display (HMD), a virtual reality (VR) display, a augmented reality (AR) display, or other such output device. The display device 117 allows the GUI module 110 to output visual information to a user.

In some implementations, the GUI module 110 displays a GUI on the display device 117 to a user of the user terminal 102. A GUI is a type of user interface that allows users to interact with electronic devices through graphical icons and visual indicators such as secondary notation, instead of text-based user interfaces, typed command labels or text navigation. A GUI uses a combination of technologies and devices to provide a platform for the tasks of gathering and producing information from users. The actions in a GUI are usually performed through direct manipulation of the graphical elements.

The GUI module 110 of the user terminal 102 allows a user to input commands and data using the input module 112. The input module 112 of the GUI 110 allows the user terminal 102 to receive data from a user through the input device 116. The input device 116 can be at least one of a mouse, a keyboard, a touchscreen, a trackpad, or other similar control device. The input device 116 allows a user to provide input data into the input module 112. In some implements, the user terminal 102 receives data over a network in addition to or alternatively to receiving data from the input module 112.

For example, the input module 112 can show various dialogs, text boxes, drop down boxes, menus, buttons, checklists, to allow the user to input the lab data, the equipment data, and scheduling requests, using the input device 116.

In some implementations, the user can input lab data for the lab locations and equipment data using the input module 112. In some implementations, the lab data and/or equipment data is received over the network. For example, the lab data can include data relating to each lab, such as building identification, room identification, address, lab size, manager name, investigator name, or lab capabilities. For example, the equipment data comprises at least one of states of calibration, customer satisfaction, workmanship standards, training records, documented procedures, process controls, survey data, usage records, or user evaluations.

The GUI module 110 can also include a calendar module 114 for use by the user in viewing availability of equipment from one of the labs. The user can use the calendar module 114 to request to use a particular equipment at a particular date/time.

The server 104 is a processing device such as a server computer, a desktop computer, a laptop, a tablet, a smartphone, a mobile device, a virtual machine, or other such device. The server 104 includes a processor 120 and a memory 130 for storing data.

The processor 120 includes a risk assessment module 122, a request module 124, and a scheduling module 126. The risk assessment module 122 determines a risk score for the equipment in the labs based on the lab data and the equipment data. For example, the risk assessment module 122 can base the risk score on safety ratings given to the equipment, the amount of time since a last safety check, user evaluations, malfunction history, age, amount of total usage, certifications, lab conditions, or other such criteria provided in the lab data and the equipment data. For example, the risk score can be a number between 0 (worst) and 100 (best). In some implementations, the risk score can be displayed to the user by the GUI module 110. For example, if the risk score is between 90 and 100, a gold star can be shown. If the risk score is between 80 and 89, a silver star can be shown, etc.

The scheduling module 126 determines a schedule which equipment is available for requested use in which labs and which equipment is not available for requested use, on which dates and/or times. The scheduling module 126 logs the dates and times of use of each equipment and tracks of which lab each equipment is. The calendar module 114 of user terminal 102 can then display a calendar on the display 117 to represent the dates and/or times the equipment is available.

The request module 124 determines whether to grant the request for the equipment based on the risk score and the schedule for the one of the plurality of equipment. For example, the request module 124 determines from the schedule of the scheduling module 126, whether the equipment is or will be in use on the requested date and/or time. If the equipment is available based on the schedule, then the request module 124 determines whether the risk score is over a threshold. For example, if the threshold is 80 and the risk score for the equipment is 75, the request module 124 will deny the request.

The memory 130 stores the equipment data 132, the lab data 134, the risk score 136, and other such data. The memory 130 can include any physical device used to temporarily or permanently store data or programs, such as various forms of random-access memory (RAM). The memory 130 can include any physical device for non-volatile data storage such as a HDD or a flash drive. HDDs can have a greater capacity than RAM or SSDs and can be more economical per unit of storage, but can also have slower transfer rates.

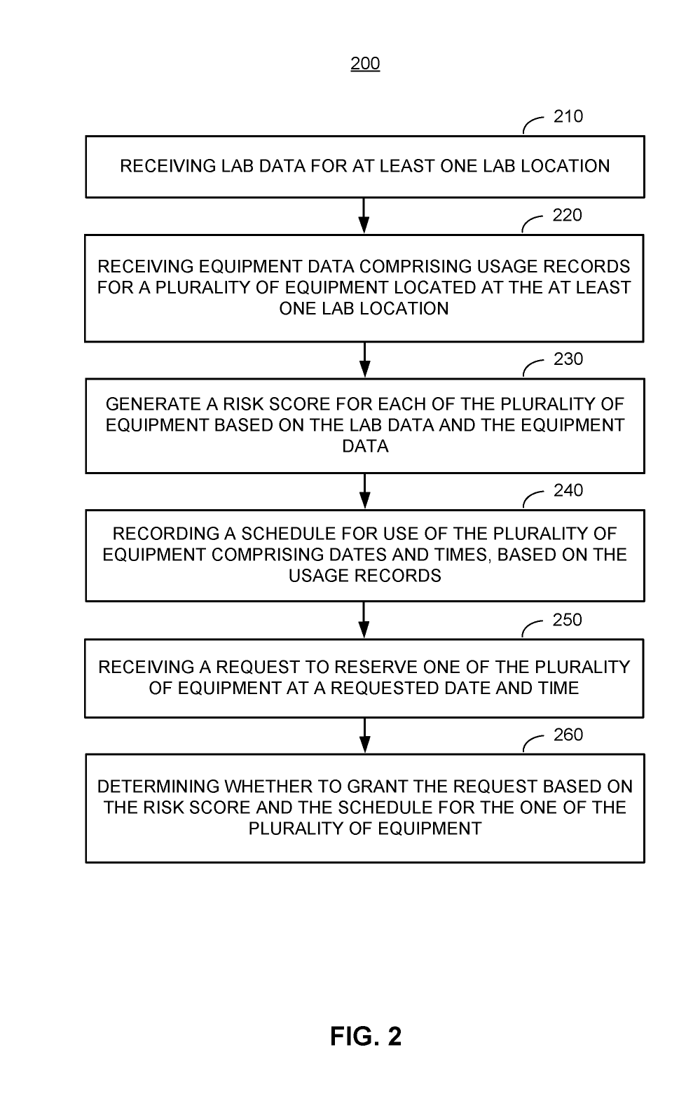

FIG. 2 illustrates an example methodology 200 for managing equipment quality, by a management system. At step 210, the management system receives lab data for at least one lab location. In some implementations, the lab data comprises at least one of building identification, room identification, address, lab size, manager name, investigator name, or lab capabilities. In some implementations, the lab data comprises at least one of a certification document.

At step 220, the management system receives equipment data comprising usage records for a plurality of equipment located at the at least one lab location. In some implementations, the equipment data comprises at least one of states of calibration, customer satisfaction, workmanship standards, training records, documented procedures, process controls, survey data, usage records, or user evaluations. In some implementations, the management system displays a calendar of dates of use for each of the plurality of equipment.

At step 230, the management system generates a risk score for each of the plurality of equipment based on the lab data and the equipment data. In some implementations, the management system sends, in response to the risk score for a particular equipment being below a risk threshold, an alert to a manager for a lab location associated with the particular equipment. In some implementations, the management system labels each of the plurality of equipment as one of a plurality of categories based on the risk score.

In some implementations, the management system provides the lab data, the equipment data, and the risk score to a user by a user interface.

At step 240, the management system records a schedule for use of the plurality of equipment comprising dates and times, based on the usage records.

At step 250, the management system receives a request to reserve one of the plurality of equipment at a requested date and time.

At step 260, the management system determining whether to grant the request based on the risk score and the schedule for the one of the plurality of equipment. In some implementations, determining whether to grant the request is based on whether the schedule shows that the one of the plurality of equipment requested is available, and on whether the risk score is over a threshold.

At step 270, the management system provides an equipment lending program that automates the loan process through the on-line database of equipment available for loan, formalize the loan agreement and develop an electronic record of the equipment when it is transferred and returned.

In some implementations, the management system displays, in response to determining to grant the request, location information for the one of the plurality of equipment requested.

In some implementations, the management system sends a notification to each of a list of users for signing an uploaded document, and receives signatures for the uploaded document from the list of users. The management system determines a set of users that have not sent a signature for the uploaded document, and periodically resends the notification to the set of users.

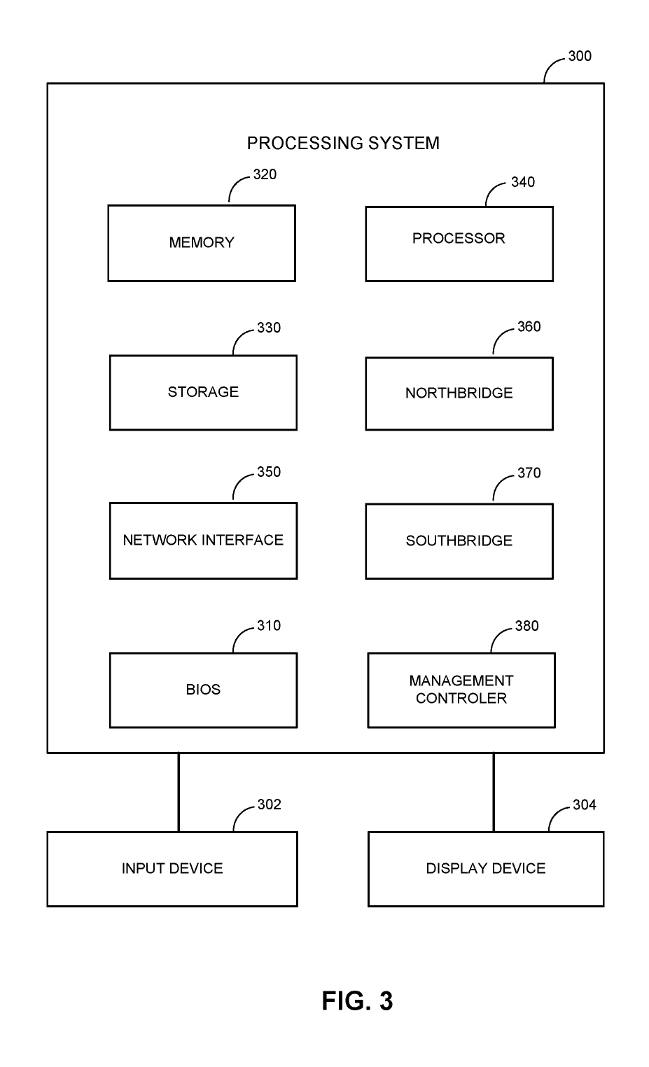

FIG. 3 illustrates a block diagram of an example processing system 300. The processing system 300 can include a processor 340, a network interface 350, a management controller 380, a memory 320, a storage 330, a Basic Input/Output System (BIOS) 310, and a northbridge 360, and a southbridge 370.

The processing system 300 can be, for example, a server (e.g., one of many rack servers in a data center) or a personal computer. The processor (e.g., central processing unit (CPU)) 340 can be a chip on a motherboard that can retrieve and execute programming instructions stored in the memory 320. The processor 340 can be a single CPU with a single processing core, a single CPU with multiple processing cores, or multiple CPUs. One or more buses (not shown) can transmit instructions and application data between various computer components such as the processor 340, memory 320, storage 330, and networking interface 350.

The memory 320 can include any physical device used to temporarily or permanently store data or programs, such as various forms of random-access memory (RAM), read-only memory (ROM), or solid state memory. The storage 330 can include any physical device for non-volatile data storage such as a hard-disk drive (HDD) or solid-state drive (SSD). The storage 330 can have a greater capacity than the memory 320 and can be more economical per unit of storage, but can also have slower transfer rates.

The BIOS 310 can include a Basic Input/Output System or its successors or equivalents, such as an Extensible Firmware Interface (EFI) or Unified Extensible Firmware Interface (UEFI). The BIOS 310 can include a BIOS chip located on a motherboard of the processing system 300 storing a BIOS software program. The BIOS 310 can store firmware executed when the computer system is first powered on along with a set of configurations specified for the BIOS 310. The BIOS firmware and BIOS configurations can be stored in a non-volatile memory (e.g., NVRAM) 312 or a ROM such as flash memory. Flash memory is a non-volatile computer storage medium that can be electronically erased and reprogrammed.

The BIOS 310 can be loaded and executed as a sequence program each time the processing system 300 is started. The BIOS 310 can recognize, initialize, and test hardware present in a given computing system based on the set of configurations. The BIOS 310 can perform self-test, such as a Power-on-Self-Test (POST), on the processing system 300. This self-test can test functionality of various hardware components such as hard disk drives, optical reading devices, cooling devices, memory modules, expansion cards and the like. The BIOS can address and allocate an area in the memory 320 in to store an operating system. The BIOS 310 can then give control of the computer system to the OS.

The BIOS 310 of the processing system 300 can include a BIOS configuration that defines how the BIOS 310 controls various hardware components in the processing system 300. The BIOS configuration can determine the order in which the various hardware components in the processing system 300 are started. The BIOS 310 can provide an interface (e.g., BIOS setup utility) that allows a variety of different parameters to be set, which can be different from parameters in a BIOS default configuration. For example, a user (e.g., an administrator) can use the BIOS 310 to specify clock and bus speeds, specify what peripherals are attached to the computer system, specify monitoring of health (e.g., fan speeds and CPU temperature limits), and specify a variety of other parameters that affect overall performance and power usage of the computer system.

The management controller 380 can be a specialized microcontroller embedded on the motherboard of the computer system. For example, the management controller 380 can be a BMC or a RMC. The management controller 380 can manage the interface between system management software and platform hardware. Different types of sensors built into the computer system can report to the management controller 380 on parameters such as temperature, cooling fan speeds, power status, operating system status, etc. The management controller 380 can monitor the sensors and have the ability to send alerts to an administrator via the network interface 350 if any of the parameters do not stay within preset limits, indicating a potential failure of the system. The administrator can also remotely communicate with the management controller 380 to take some corrective action such as resetting or power cycling the system to restore functionality.

The northbridge 360 can be a chip on the motherboard that can be directly connected to the processor 340 or can be integrated into the processor 340. In some instances, the northbridge 360 and the southbridge 370 can be combined into a single die. The northbridge 360 and the southbridge 370, manage communications between the processor 340 and other parts of the motherboard. The northbridge 360 can manage tasks that require higher performance than the southbridge 370. The northbridge 360 can manage communications between the processor 340, the memory 320, and video controllers (not shown). In some instances, the northbridge 360 can include a video controller.

The southbridge 370 can be a chip on the motherboard connected to the northbridge 360, but unlike the northbridge 360, is not directly connected to the processor 340. The southbridge 370 can manage input/output functions (e.g., audio functions. BIOS, Universal Serial Bus (USB), Serial Advanced Technology Attachment (SATA), Peripheral Component Interconnect (PCI) bus, PCI eXtended (PCI-X) bus, PCI Express bus, Industry Standard Architecture (ISA) bus, Serial Peripheral Interface (SPI) bus, Enhanced Serial Peripheral Interface (eSPI) bus, System Management Bus (SMBus), etc.) of the processing system 300. The southbridge 370 can be connected to or can include within the southbridge 370 the management controller 370, Direct Memory Access (DMAs) controllers, Programmable Interrupt Controllers (PICs), and a real-time clock.

The input device 302 can be at least one of a game controller, a joystick, a mouse, a keyboard, a touchscreen, a trackpad, or other similar control device. The input device 302 allows a user to provide input data to the processing system 300.

The display device 304 can be at least one of a monitor, a light-emitting display (LED) screen, a liquid crystal display (LCD) screen, a head mounted display (HMD), a virtual reality (VR) display, a augmented reality (AR) display, or other such output device. The display device 304 allows the processing system 300 to output visual information to a user.

The various illustrative logical blocks, modules, and circuits described in connection with the disclosure herein can be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The operations of a method or algorithm described in connection with the disclosure herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

In one or more exemplary designs, the functions described can be implemented in hardware, software, firmware, or any combination thereof. If implemented in software, the functions can be stored on or transmitted over as one or more instructions or code on a non-transitory computer-readable medium. Non-transitory computer-readable media includes both computer storage media and communication media including any medium that facilitates transfer of a computer program from one place to another. A storage media can be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and blue ray disc where disks usually reproduce data magnetically, while discs reproduce data optically with lasers. Combinations of the above should also be included within the scope of non-transitory computer-readable media.

The previous description of the disclosure is provided to enable any person skilled in the art to make or use the disclosure. Various modifications to the disclosure will be readily apparent to those skilled in the art, and the generic principles defined herein can be applied to other variations without departing from the scope of the disclosure. Thus, the disclosure is not intended to be limited to the examples and designs described herein, but is to be accorded the widest scope consistent with the principles and novel features disclosed herein.

1. A method for managing equipment quality, by a management system, comprising:
receiving lab data for at least one lab location;
receiving equipment data comprising usage records for a plurality of equipment located at the at least one lab location;
generating a risk score for each of the plurality of equipment based on the lab data and the equipment data;
recording a schedule for use of the plurality of equipment comprising dates and times, based on the usage records;
receiving a request to reserve one of the plurality of equipment at a requested date and time; and
determining whether to grant the request based on the risk score and the schedule for the one of the plurality of equipment.

2. The method of claim 1, further comprising sending, in response to the risk score for a particular equipment being below a risk threshold, an alert to a manager for a lab location associated with the particular equipment.

3. The method of claim 1, further comprising displaying, in response to determining to grant the request, location information for the one of the plurality of equipment requested.

4. The method of claim 1, further comprising displaying a calendar of dates of use for each of the plurality of equipment.

5. The method of claim 1, wherein the lab data comprises at least one of building identification, room identification, address, lab size, manager name, investigator name, or lab capabilities.

6. The method of claim 1, wherein the equipment data comprises at least one of states of calibration, customer satisfaction, workmanship standards, training records, documented procedures, process controls, survey data, usage records, or user evaluations.

7. The method of claim 1, wherein determining whether to grant the request is based on whether the schedule shows that the one of the plurality of equipment requested is available, and on whether the risk score is over a threshold.

8. The method of claim 1, further comprising labeling each of the plurality of equipment as one of a plurality of categories based on the risk score.

9. The method of claim 1, wherein the lab data comprises at least one of a certification document.

10. The method of claim 1, further comprising providing the lab data, the equipment data, and the risk score to a user by a user interface.

11. The method of claim 1, further comprising:
sending a notification to each of a list of users for signing an uploaded document;
receiving signatures for the uploaded document from the list of users;
determining a set of users that have not sent a signature for the uploaded document; and
periodically resending the notification to the set of users.

12. A computer program product, comprising:
a non-transitory computer-readable medium comprising code for causing at least one computer to:
receive lab data for at least one lab location;
receive equipment data comprising usage records for a plurality of equipment located at the at least one lab location;
generate a risk score for each of the plurality of equipment based on the lab data and the equipment data record a schedule for use of the plurality of equipment comprising dates and times, based on the usage records;
receive a request to reserve one of the plurality of equipment at a requested date and time; and
determine whether to grant the request based on the risk score and the schedule for the one of the plurality of equipment.

13. A system for managing equipment quality, comprising:
a graphical user interface configured to:
receive lab data for at least one lab location:
receive equipment data comprising usage records for a plurality of equipment located at the at least one lab location;
record a schedule for use of the plurality of equipment comprising dates and times, based on the usage records;
receive a request to reserve one of the plurality of equipment at a requested date and time; and
a processor configured to:
generate a risk score for each of the plurality of equipment based on the lab data and the equipment data; and
determine whether to grant the request based on the risk score and the schedule for the one of the plurality of equipment; and
a memory coupled to the processor for storing data.
